(19) United States
(12) Patent Application Publication
(10) Pub. No.: US 2009/0237588 A1
(43) Pub. Date: Sep. 24, 2009

(54) LIQUID CRYSTAL DISPLAY DEVICE

(75) Inventors: Yuuichi Takenaka, Chiba (JP); Shinji Yasukawa, Shirako (JP); Yukihide Ode, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/407,056

(22) Filed: Mar. 19, 2009

(30) Foreign Application Priority Data
Mar. 19, 2008 (JP) 2008-071373

(51) Int. Cl. G02F 1/1333

(52) U.S. Cl. 349/58

(57) ABSTRACT

An object of the present invention is to provide a technology which makes it possible for the heat from parts having high heat emission mounted on a printed circuit board provided between an upper frame member and a side of the liquid crystal display panel or the backlight to be released efficiently in liquid crystal display devices where the above described parts are mounted. The present invention provides a liquid crystal display device, having: a liquid crystal display panel; a number of flexible wiring boards connected to the above described liquid crystal display panel; a first drive circuit and a second drive circuit provided on the above described flexible wiring boards or the above described liquid crystal display panel; a printed circuit board having wires for transmitting an external signal to the above described first drive circuit and second drive circuit and connected to the above described flexible wiring boards; a semiconductor device mounted on the above described printed circuit board; and an upper frame member made of a metal which covers an outer periphery portion of the above described liquid crystal display panel and the above described printed circuit board, wherein a heat conducting member having heat conductance is provided on the surface of the above described printed circuit board which faces the above described upper frame member, and the above described heat conducting member makes contact with the above described upper frame member.

The present application claims priority over Japanese application JP2008-071373 filed on Mar. 19, 2008, the content of which is hereby incorporated into this application by reference.

### BACKGROUND OF THE INVENTION

(1) Field of the Invention

The present invention relates to a liquid crystal display device, and in particular, to a technology which is effective when applied for an active matrix type TFT liquid crystal display device.

(2) Related Art Statement

Conventional liquid crystal display devices are used as display devices (display means) of various products, and one of these products is a liquid crystal television set.

Liquid crystal television sets are formed of various parts, and the core of these parts is a part that is referred to as liquid crystal display module. In addition to the above described liquid crystal display module, various parts, for example, a power supply unit, a speaker and signal input terminals, are installed or contained in the housing of the above described liquid crystal television sets.

Liquid crystal display modules used for general liquid crystal television sets have a liquid crystal display panel where a pair of substrates sandwich a liquid crystal material, a backlight unit which illuminates the above described liquid crystal display panel with light, and a frame member for supporting the above described display panel and the above described backlight unit integrally, for example.

In addition to the above, the above described liquid crystal display modules have first flexible wiring boards connected to the periphery of the liquid crystal display panel, a first printed circuit board having a timing controller circuit (T-CON circuit), a second flexible wiring board for transmitting a signal processed in the first printed circuit board to the first flexible wiring board, and a second printed circuit board.

In addition, the above described first flexible wiring boards include a flexible wiring board on which a semiconductor chip (source driver) for supplying a video signal to the above described liquid crystal display panel is mounted and another flexible wiring board on which a semiconductor chip (gate driver) for supplying a scanning signal to the liquid crystal display panel is mounted, for example. At this time, the flexible wiring board on which the above described source driver is mounted and the flexible wiring board on which the above described gate driver is mounted are directly connected to the outer periphery portion of the above described liquid crystal display panel.

There are various configurations in the above described liquid crystal display panel and the above described backlight unit in the above described liquid crystal display module as well as in the above described flexible wiring boards and the above described printed circuit boards, and there are various methods in the method for support using the above described frame member (see, for example, Patent Document 1 and Patent Document 2).

[Patent Document 1] Japanese Unexamined Patent Publication 2001-83897 (Corresponding U.S. Pat. No. 6,636,281 B1)

[Patent Document 2] Japanese Unexamined Patent Publication 2005-300821 (Corresponding US Patent Application Publication US/2005/0225708 A1)

### SUMMARY OF THE INVENTION

### (Problem to be Solved by the Invention)

An increase in the definition of the liquid crystal display panel (display region) and an increase in the moving image displaying performance have been required in liquid crystal television sets in recent years in order to be adjusted to a broadcasting system, which is referred to as full high vision, for example.

Methods for improving the moving image displaying performance of liquid crystal television sets include a method for driving the liquid crystal television set with 120 Hz (hertz), for example, and it is necessary to increase the performance of the source driver for supplying a video signal to the above described liquid crystal display panel (for example, an increase in the speed of operation, an increase in the output and the like) in order to drive the above described liquid crystal television set with 120 Hz, for example.

However, heat emission increases as the above described source driver operates, and it becomes easy for such a problem as malfunctioning to occur, for example, when the drive frequency increases or the output voltage increases.

The method for reducing heat emission from the source driver includes a method for providing a power supply voltage ½ AVDD, which is a middle potential between the power supply voltage AVDD of the source driver and the ground potential, so that the power is supplied from the power supply voltage ½ AVDD in the case where the output of the source driver is a low voltage. In the case where this method is used, a power supply circuit for generating a power supply voltage ½ AVDD is required in addition to the power supply circuit for generating the conventional power supply voltage AVDD.

The method for providing the power supply circuit for generating the power supply voltage ½ AVDD could possibly include a method for providing it to the above described first printed circuit board (board having T-CON circuit) and a method for providing it to the second printed circuit board connected between the above described first flexible wiring board on which the source driver is mounted and the above described first printed circuit board. At this time, surface mounting type transistors (semiconductor devices) are used in the power supply circuit for generating the power supply voltage ½ AVDD, for example.

In the case where the above described transistors are provided on the above described second printed circuit board, it is possible to reduce the cost of parts by reducing the number of wires on the second flexible wiring board and the number of terminals of the connectors which are used for the connection to the above described first printed circuit board (board having T-CON circuit) and the second printed circuit board, for example. On the other hand, however, a problem arises such that the heat from the above described transistors affects the above described second printed circuit board and peripheral members.

Measures against heat in general semiconductor devices include a method for intervening a heat conducting sheet between a semiconductor device and a case made of a metal (see, for example, Japanese Unexamined Patent Publication H10 (1998)-308484).

However, the frames of the liquid crystal television sets have been made narrower in recent years, and thus, the space that can be secured between the frame member and the sides of the liquid crystal display panels or the backlight is very limited. The above described second printed circuit board on which the above described transistors are mounted is attached to a side of the above described backlight unit, for example, so that the surface of the above described second printed circuit board on which the above described transistors are mounted faces the upper frame member in the above described frame member. Therefore, the space between the above described transistors and the above described upper frame member is smaller than the space between the above described second printed circuit board and the above described upper frame member.

In addition, the size of the above described transistors (dimensions on the mounting surface) is as small as approximately 12 mm in both the longitudinal and lateral directions. In the case where a sheet for heat conduction is intervened between the above described transistors and the above described upper frame member as described above, the above described sheet for heat conduction needs to have an area two or more times greater than the size of the above described transistors in order to gain sufficient heat releasing effects. In addition, the space between the above described transistors and the above described upper frame member is small, and therefore, the used sheet for heat conduction must be very thin. Therefore, the outer periphery portion of the sheet for heat conduction bends when pasted to the top of the above described transistors, for example, and it is difficult to paste the entire surface of the sheet to the above described upper frame member.

This structure, which is specific to the liquid crystal display modules, makes it difficult for a sheet for heat conduction having an area that is large enough for heat release from the above described transistors to be inserted between the above described transistors and the above described upper frame member, for example.

Furthermore, the above described transistors are resin molded semiconductor devices where the periphery of a semiconductor chip, which is the source of heat, is covered with a resin having a low heat conductance. Therefore, a problem arises such that sufficient heat releasing effects are not gained even in the case where the above described sheet for heat conduction is simply provided so as to make contact with the above described transistors and the above described upper frame member.

Thus, liquid crystal display modules having a conventional power supply circuit for generating the power supply voltage ½ AVDD have such a problem that heat cannot be efficiently released due to the lack of contact area between the above described sheet for heat conduction and the above described transistors (and upper frame member), due to low efficiency in heat dispersion because the above described sheet for heat conduction is thin, and due to low efficiency in heat conduction because of the material for molding the above described transistors.

An object of the present invention is to provide a technology which makes it possible for the heat from parts having high heat emission mounted on a printed circuit board provided between an upper frame member and a side of the liquid crystal display panel or the backlight to be released efficiently in liquid crystal display devices where the above described parts are mounted.

The above described and other objects and novel features of the present invention will be clarified from the description of the present specification and the accompanying drawings.

### (Means for Solving Problem)

Typical inventions from among the inventions disclosed in the present specification are briefly described in the following.

(1) A liquid crystal display device, comprising: a liquid crystal display panel; a number of flexible wiring boards connected to the above described liquid crystal display panel; a first drive circuit and a second drive circuit provided on the above described flexible wiring boards or the above described liquid crystal display panel; a printed circuit board having wires for transmitting an external signal to the above described first drive circuit and second drive circuit and connected to the above described flexible wiring boards; a semiconductor device mounted on the above described printed circuit board; and an upper frame member made of a metal which covers an outer periphery portion of the above described liquid crystal display panel and the above described printed circuit board, wherein a heat conducting member having heat conductance is provided on the surface of the above described printed circuit board which faces the above described upper frame member, and the above described heat conducting member makes contact with the above described upper frame member.

(2) In the liquid crystal display device according to the above (1), the liquid crystal display device has a backlight unit provided on the rear of the above described liquid crystal display panel, and the above described printed circuit board is provided between a side portion of the above described backlight unit and the above described upper frame member.

(3) In the liquid crystal display device according to the above (1), the above described heat conducting member has an opening or a recess on the surface facing the above described printed circuit board, and the above described semiconductor device is provided on the surface of the above described printed circuit board facing the above described upper frame member and in the above described opening or recess of the above described heat conducting member.

(4) In the liquid crystal display device according to the above (1), the above described semiconductor device is provided on the surface of the above described printed circuit board facing the above described upper frame member, and the above described heat conducting member is provided in the vicinity of the above described semiconductor device that is located on the surface of the above described printed circuit board facing the above described upper frame member.

(5) In the liquid crystal display device according to the above (1), a number of semiconductor devices are provided on the surface of the above described printed circuit board facing the above described upper frame member, and one or more heat conducting members are provided corresponding to the number and the locations of the above described semiconductor devices.

(6) In the liquid crystal display device according to the above (1), the above described semiconductor device has a heat releasing terminal for conducting heat to the above described printed circuit board, and the above described heat releasing terminal makes contact with the above described heat conducting member.

(7) In the liquid crystal display device according to the above (1), the above described first drive circuit is a drive circuit for sending a video signal to the above described liquid crystal display panel, and the above described semiconductor device is a transistor for generating a power applied to the above described first drive circuit.

(8) In the liquid crystal display device according to the above (1), the above described first drive circuit and the above described second drive circuit are integrated circuit parts in chip form, respectively, and mounted on the above described flexible wiring boards.

(9) In the liquid crystal display device according to the above (1), the above described heat conducting member is formed of an elastic body.

(10) In the liquid crystal display device according to the above (1), the height of the above described heat conducting member from the surface of the above described printed circuit board facing the above described upper frame member is greater than the height of the above described semiconductor device from the surface facing the above described upper frame member.

(11) In the liquid crystal display device according to the above (1), the area of the surface of the above described heat conducting member which makes contact with the above described printed circuit board and the surface of the above described heat conducting member which makes contact with the above described upper frame member is greater than the area of the region occupied by the above described semiconductor device on the above described printed circuit board.

### (Effects of the Invention)

In the liquid crystal display device according to the present invention, a semiconductor device having high heat emission (for example, transistor for power supply) is mounted on a printed circuit board provided between an upper frame member and a side of a liquid crystal display panel or the backlight, and thus, heat can be efficiently released from the above described semiconductor device even in the case where the space between the above described upper frame member and the above described printed circuit board is small.

### BRIEF DESCRIPTION OF THE DRAWINGS

FIG. 1A is a schematic frontal diagram showing the configuration of an example of a conventional liquid crystal display module;

FIG. 1B is an exploded perspective diagram showing the liquid crystal display module shown in FIG. 1A;

FIG. 1C is a schematic cross sectional diagram showing the configuration of the example along line A-A′ in FIG. 1A;

FIG. 1D is a schematic plan diagram showing the configuration of examples of the liquid crystal display panel, the flexible wiring board and the printed circuit board in the liquid crystal display module shown in FIG. 1A;

FIG. 2A is a schematic plan diagram showing the configuration of an example of a main portion in the liquid crystal display module according to the first embodiment of the present invention;

FIG. 2B is a schematic cross sectional diagram showing the configuration of the example along line B-B′ in FIG. 2A;

FIG. 2C is a schematic cross sectional diagram showing the configuration of the example along line C-C′ in FIG. 2A;

FIG. 3A is a schematic plan diagram showing the configuration of an example of a main portion in the modification of the first embodiment;

FIG. 3B is a schematic cross sectional diagram showing the configuration of the example along line D-D′ in FIG. 3A;

FIG. 3C is a schematic cross sectional diagram showing the configuration of the example along line E-E′ in FIG. 3A; and

FIG. 4 is a schematic diagram showing the configuration of a modification of a main portion in the liquid crystal display module according to the second embodiment of the present invention.

### EXPLANATION OF SYMBOLS

1 . . . liquid crystal display panel

101 . . . TFT substrate

102 . . . facing substrate

103 . . . liquid crystal material

104 . . . sealing material

101D . . . video signal line

101G . . . scan signal line

2A, 2B . . . first flexible wiring board

3 . . . first printed circuit board

4 . . . second flexible wiring board

5 . . . second printed circuit board

6 . . . backlight unit

601 . . . lower frame member

602 . . . reflective plate

603 . . . fluorescent lamp

604 . . . optical sheet

7 . . . molded frame

8 . . . upper frame member

9A . . . source driver

9B . . . gate driver

10 . . . semiconductor device

1001 . . . heat releasing terminal

1002 . . . semiconductor chip

1003 . . . lead

1004 . . . bonding wire

1005 . . . sealing material

11 . . . insulating sheet

12 . . . heat conducting member

12a, 12b . . . opening

### DETAILED DESCRIPTION OF THE INVENTION

In the following, the preferred embodiments of the present invention are described in detail in reference to the drawings.

Here, the same symbols are attached to the components having the same function for all the drawings showing the embodiments, and the descriptions are not repeated.

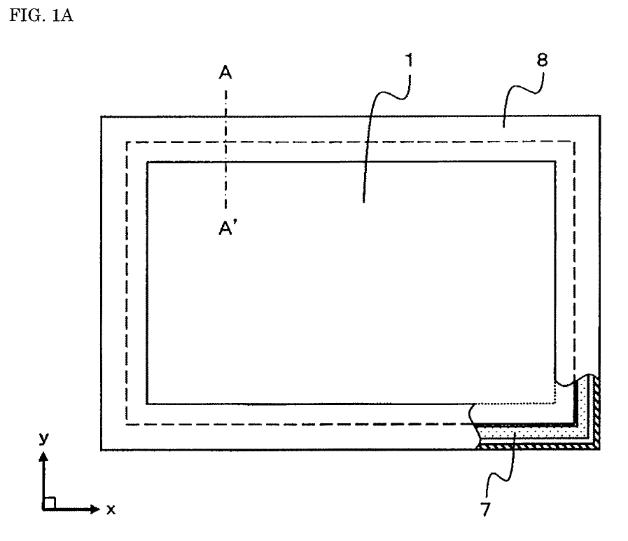

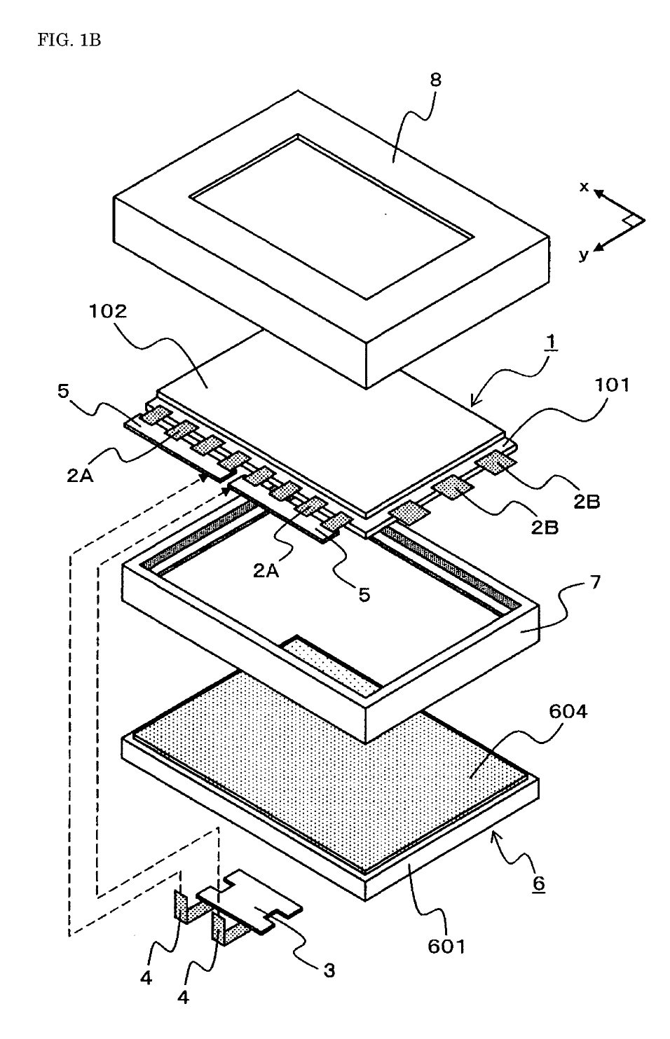

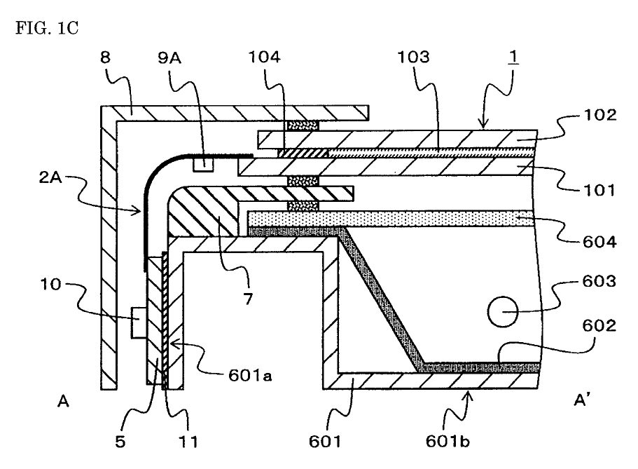

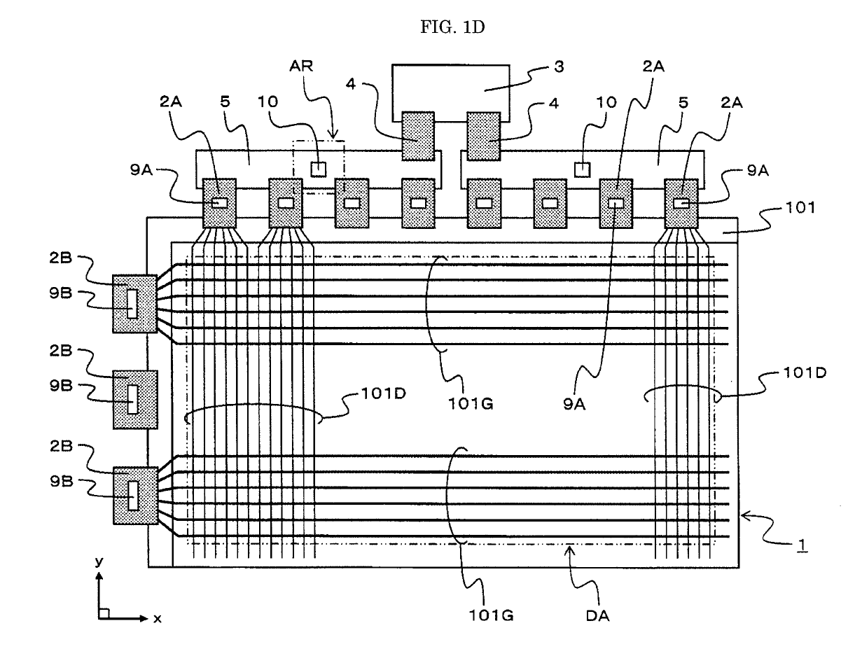

FIGS. 1A to 1D are schematic diagrams showing the configuration of an example of a conventional liquid crystal display module in comparison with the present invention.

FIG. 1A is a schematic frontal diagram showing the configuration of an example of a conventional liquid crystal display module. FIG. 1B is an exploded perspective diagram showing the liquid crystal display module in FIG. 1A. FIG. 1C is a schematic cross sectional diagram showing the configuration of the example along line A-A′ in FIG. 1A. FIG. 1D is a schematic plan diagram showing the configuration of examples of the liquid crystal display panel, the flexible wiring board and the printed circuit board in the liquid crystal display module shown in FIG. 1A.

Here, the direction x and the direction y shown in FIGS. 1B and 1D are the same as the direction x and the direction y shown in FIG. 1A, respectively. In addition, FIG. 1D shows the flexible wiring boards and the printed circuit board connected to the liquid crystal display panel laid out in a plane parallel to the display surface of the liquid crystal display panel.

The present invention can be applied to liquid crystal display modules used for liquid crystal display devices, such as liquid crystal television sets, for example. At this time, as shown in FIGS. 1A to 1C, the liquid crystal display module has a liquid crystal display panel 1, first flexible wiring boards 2A and 2B, a first printed circuit board 3, second flexible wiring boards 4, a second printed circuit board 5, a backlight unit 6, a mold frame 7 and an upper frame member 8, for example.

The liquid crystal display panel 1 is a display panel where a liquid crystal material 103 is sealed between a TFT substrate 101 and a facing substrate 102. At this time, the TFT substrate 101 and the facing substrate 102 are pasted together with an annular sealing material 104 which surrounds the display region, not shown, for example, and thus, the liquid crystal material 103 is sealed in the space surrounded by the TFT substrate 101, the facing substrate 102 and the sealing material 104.

In addition, as shown in FIG. 1D, the TFT substrate 101 has a number of video signal lines 101D and a number of scan signal lines 101G, for example. Here, the video signal lines 101D, some of which are omitted in FIG. 1D, are aligned with predetermined intervals in the direction x throughout the entirety of the display region DA, and the scan signal lines 101G are aligned with predetermined intervals in the direction y throughout the entirety of the display region DA.

In addition, the display region DA of the liquid crystal display panel 1 is defined by a set of a great number of pixels, and the size of one pixel corresponds to a region surrounded by two adjacent video signal lines 101D and two adjacent scan signal lines 101G, for example. At this time, each pixel has a TFT element, a pixel electrode and a counter electrode, for example. In the case where the liquid crystal display panel 1 is of a longitudinal electrical field driving system, such as a VA system and a TN system, for example, the above described TFT elements and the above described pixel electrodes are provided on the TFT substrate 101, while the above described counter electrodes are provided on the facing substrate 102. In addition, in the case where the liquid crystal display panel 1 is of a lateral electrical field driving system, such as an IPS system, for example, the above described TFT elements, the above described pixel electrodes and the above described pixel electrodes are all provided on the TFT substrate 101.

The ends of the video signal lines 101D on the upper periphery side of the TFT substrate 101, for example, are connected to the first flexible wiring board 2A. At this time, a source driver (first drive circuit) 9A for supplying a video signal to the video signal lines 101D is mounted on the first flexible wiring board 2A. In addition, the source driver 9A is an integrated circuit device in chip form.

In addition, the source driver 9A generates a video signal on the basis of the signal from the first printed circuit board 3 having a timing controller circuit (T-CON circuit), and supplies it to a video signal line 101D. At this time, the signal from the first printed circuit board 3 passes through a second flexible wiring board 4, the second printed circuit board 5 and the first flexible wiring board 2A, and is transmitted to the source driver 9A.

In addition, the ends of the scan signal lines 101G on the left side of the TFT substrate 101 are connected to the first flexible wiring board 2B, for example. At this time, a gate driver (second drive circuit) 9B for supplying a scan signal to a scan signal line 101G is mounted on the first flexible wiring board 2B. In addition, the gate driver 9B is an integrated circuit device in chip form.

In addition, the gate driver 9B generates a scan signal on the basis of a signal from the first printed circuit board 3 and supplies it to a scan signal line 101G. At this time, the signal from the first printed circuit board 3 passes through the second flexible wiring board 4, the second printed circuit board 5, the first flexible wiring board 2A, a wire (not shown) on the TF substrate 101 and the first flexible wiring board 2B, and is transmitted to the gate driver 9B.

In addition, the liquid crystal display module according to the present invention is driven at 120 Hz, for example, and a semiconductor device 10 for reducing the amount of heat emitted from the source driver 9A is mounted on the second printed circuit board 5. The semiconductor device 10 is a semiconductor package having a power supply circuit for generating a power supply voltage ½ AVDD, which is the middle potential between the power supply voltage AVDD for the source driver 9A and the ground potential.

As shown in FIG. 1C, the backlight unit 6 provided on the rear of the liquid crystal display panel 1 has a lower frame member 601 approximately in box form, a reflective plate 602, a fluorescent lamp 603 and an optical sheet 604 made up of a light diffusing sheet and a prism sheet, for example. At this time, a mold frame 7 intervenes between the liquid crystal display panel 1 and the backlight unit 6, for example. The mold frame 7 is screwed to the lower frame member 601, for example. At this time, a cushioning material made of an elastic body intervenes between the liquid crystal display panel 1 and the mold frame 7, as well as between the backlight unit 2 (optical sheet 604) and the mold frame 7.

In addition, the liquid crystal display panel 1, the backlight unit 6 and the mold frame 7 are integrally supported the upper frame member 8, for example. The upper frame member 8 is a member gained by molding a metal plate with a die, for example, and covers the outer periphery portion and the sides of the liquid crystal display panel 1 and a side 601a of the backlight unit 6. The upper frame member 8 is screwed to the lower frame member 601 and the mold frame 7, for example.

At this time, there is a space of predetermined dimensions between the side 601a of the lower frame member 601 and the upper frame member 8, and the second printed circuit board 5 is attached to the side 601a of the lower frame member 601, that is to say, a side of the backlight unit 6, with an insulating sheet 11 in between. In addition, the first printed circuit board 3, not shown, is attached to the bottom 601b of the lower frame member 601, for example.

The present invention relates to liquid crystal display devices having a liquid crystal display module having such a structure, and releases heat generated by the semiconductor device 10 efficiently in accordance with the following method.

### First Embodiment

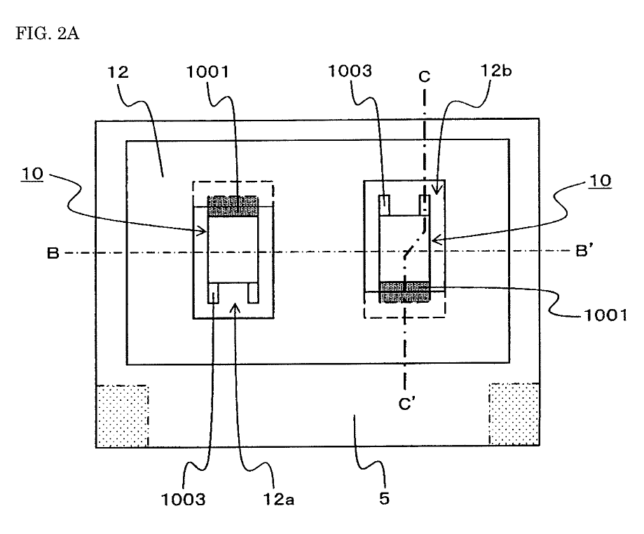

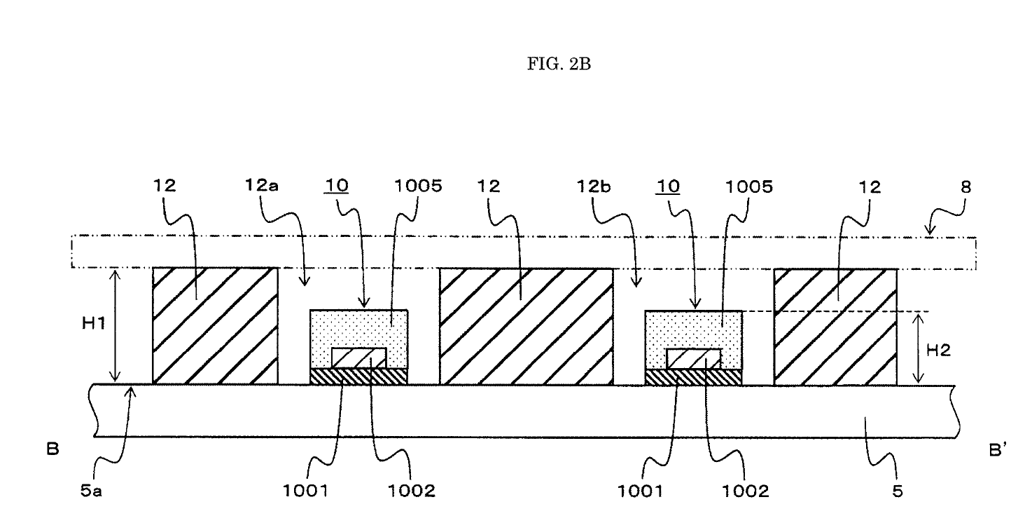

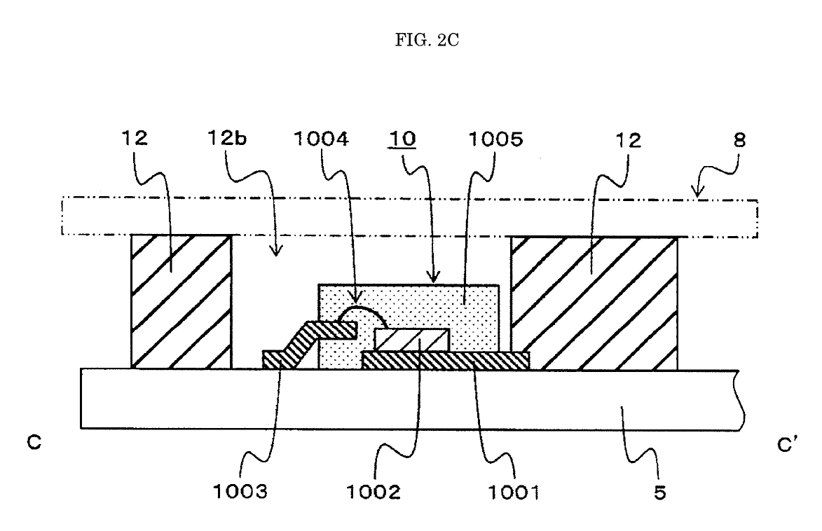

FIGS. 2A to 2C are schematic diagrams showing the configuration of a main portion of an example of the liquid crystal display module according to the first embodiment of the present invention.

FIG. 2A is a schematic plan diagram showing the configuration of a main portion of an example of the liquid crystal display module according to the first embodiment of the present invention. FIG. 2B is a schematic cross sectional diagram showing the configuration of the example along line B-B in FIG. 2A. FIG. 2C is a schematic cross sectional diagram showing the configuration of the example along line C-C′ in FIG. 2A.

Here, FIG. 2A is a plan diagram showing an enlargement of the portion of the region AR in FIG. 1D.

As shown in FIGS. 2A to 2C, in the liquid crystal display module according to the first embodiment, a heat conducting member 12 having heat conductance is placed on the surface of the second printed circuit board 5, on which a semiconductor device 10 is mounted. The semiconductor devices 10 are transistors having a power supply circuit for generating a power supply voltage ½ AVDD, which is a middle potential between the power supply voltage AVDD for the source driver 9A and the ground potential, and one for supplying the power supply voltage ½ AVDD, which is a middle potential with the source driver 9A, and one for supplying the power supply voltage at the ground potential to the source driver 9A are provided on the second printed circuit board 5 as a pair.

At this time, a semiconductor chip 1002 is mounted on a heat releasing terminal 1001, for example, in each semiconductor device 10, and the external electrodes of the semiconductor chip 1002 are connected to leads 1003 through bonding wires 1004. At this time, the semiconductor chips 1002 are surrounded and sealed in a sealing material 1005 made of a thermosetting resin. In addition, the heat releasing terminals 1001 of the semiconductor devices 10 make contact with the second printed circuit board 5, and the leads 1003 are connected to the wires (not shown) on the second printed circuit board 5.

In addition, the heat conducting member 12 is formed of an elastic body, such as of rubber, and have openings 12a and 12b ranging from the surface that makes contact with the second printed circuit board 5 to the rear in locations corresponding to the pairs of semiconductor devices 10 (location where the semiconductor devices are mounted). At this time, one semiconductor device in each pair of (two) semiconductor devices 10 is located in the opening 12a and the other is located in the opening 12b. At this time, the heat releasing terminal 1001 of each semiconductor device 10 makes contact with the heat conducting member 12.

In addition, the height HI of the heat conducting member 12 from the surface 5a of the second printed circuit board 5 facing the upper frame member 8 is greater than the height H2 of the semiconductor device 10 from the facing surface 5a. At this time, the height H1 of the heat conducting member 12 is the same or slightly greater than the space between the upper frame member 8 and the side 601a of the lower frame member 601. Furthermore, the area on the surface the heat conducting member 12 that makes contact with the second printed circuit board 5 and the area on the rear surface are greater than the area through which the semiconductor device is mounted, that is to say, the area of the region occupied by the semiconductor device 10 on the second printed circuit board 5. Thus, the heat conducting member 12 makes contact with the upper frame member 8 when the second printed circuit board 5 is provided between the upper frame member 8 and the side 601a of the lower frame member 601, and the area of contact between the heat conducting member 12 and the second printed circuit board 5 and the area of contact between the heat conducting member 12 and the upper frame member 8 are large. Therefore, heat generated in the semiconductor device 10, which diffuses through the second printed circuit board 10, can be released to the upper frame member 8 with high efficiency via the heat conducting member 12.

Here, though in the example in FIG. 1D, four first flexible wiring boards 2A (four source drivers 9A) are connected to and a pair of semiconductor devices 10 mounted on one second printed circuit board 5, two pairs or four pairs of semiconductor devices 10 may be mounted on one second printed circuit board 5, for example. In this case, heat conducting members 12 having the same structure may be provided around each pair of semiconductor devices 10.

In addition, though in the example shown in FIG. 1D, four first flexible wiring boards 2A (four source drivers 9A) are connected to one second printed circuit board 5, another appropriate number of first flexible wiring boards 2A connected to one second printed circuit board 5, that is to say, the number of source drivers 9A may be used. Thus, the number of pairs of semiconductor devices 10 mounted on the second printed circuit board 5 can be changed in accordance with the number of source drivers 9A connected to the second printed circuit board 5. Accordingly, the same number of heat conducting members 12 as there are pairs of semiconductor devices 10 mounted on the second printed circuit board 5 may be provided in the periphery of the respective pairs of semiconductor devices 10.

In addition, though openings 12a and 12b ranging from the surface that makes contact with the second printed circuit board 5 to the rear surface are provided in the heat conducting member 12 in the example in FIGS. 2A to 2C, the invention is not limited to this, and in another example, the surface that makes contact with the second printed circuit board 5 may have openings and recesses which are deeper than the height H2 of the semiconductor devices 10 may be provided, so that the semiconductor devices 10 can be contained in the recesses.

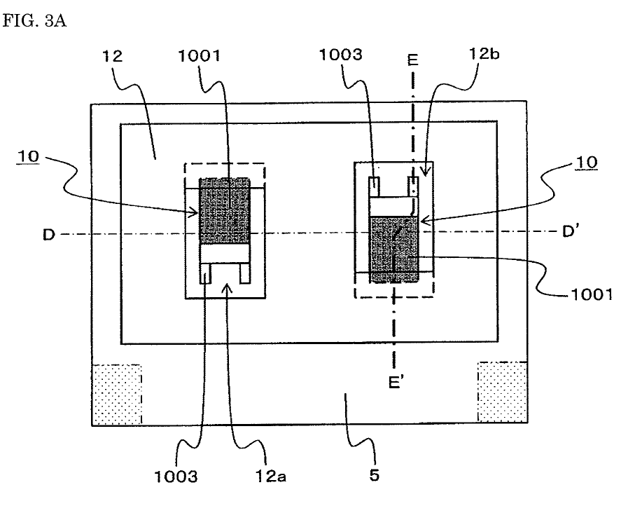

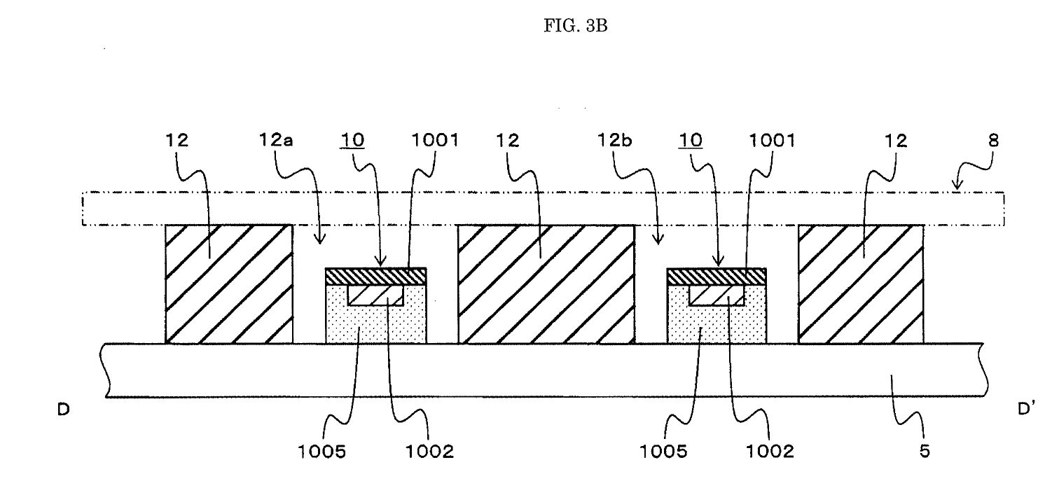

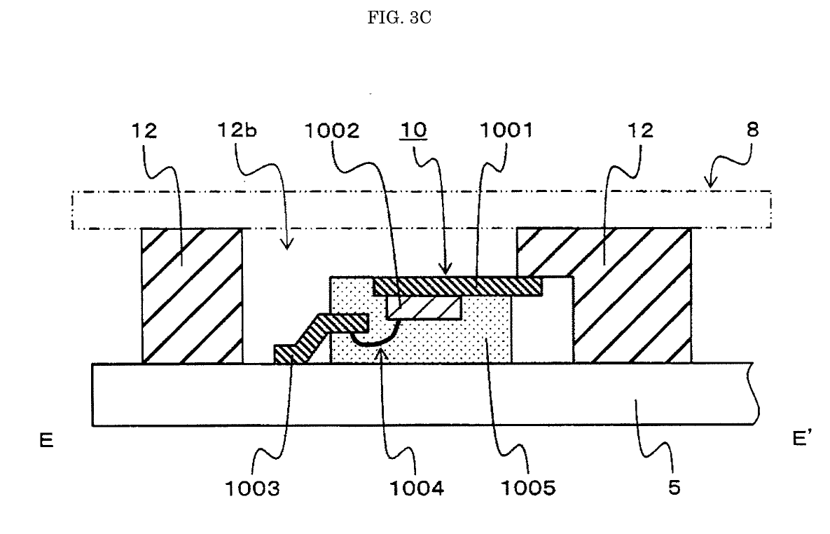

FIGS. 3A to 3C are schematic diagrams showing a modified configuration for the main portion in the liquid crystal display module according to the first embodiment.

FIG. 3A is a schematic plan diagram showing a modified configuration for the main portion in the first embodiment. FIG. 3B is a schematic cross sectional diagram showing the configuration of the example along line D-D′ in FIG. 3A. FIG. 3C is a schematic cross sectional diagram showing the configuration of the example along line E-E′ in FIG. 3A.

Here, as FIG. 2A, FIG. 3A is a plan diagram showing an enlargement of a portion of the region AR in FIG. 1D.

In the liquid crystal display module according to the first embodiment, heat generated in the semiconductor devices 10 which diffuses through the second printed circuit board 5 is conveyed to the upper frame member 8 via the heat conducting member 12 and released to the outside of the liquid crystal display module. At this time, as shown in FIGS. 2B and 2C, the semiconductor devices 10 are mounted so that the heat releasing plates 1001 make contact with the second printed circuit plate 5, and thus, heat can be efficiently released from the semiconductor devices 10 to the second printed circuit board 5, and heat generated from the semiconductor devices 10 can be efficiently released.

As shown in FIGS. 3A to 3C, however, when the semiconductor devices 10 are mounted on the second printed circuit board 5, the rear of the surface on which the heat releasing terminals 1001 are provided may make contact with the second printed circuit board 5, for example.

### Second Embodiment

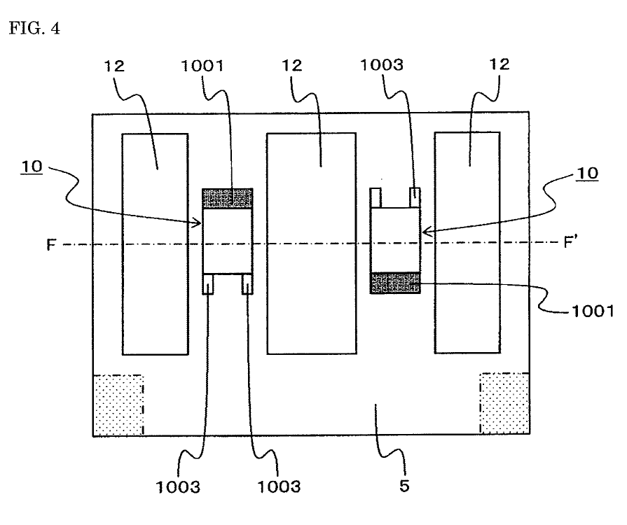

FIG. 4 is a schematic diagram showing the configuration of the main portion of a modified liquid crystal display module according to the second embodiment of the present invention.

Here, FIG. 4 is a plan diagram showing an enlargement of the portion of the region AR in FIG. 1D.

In the first embodiment, an example of a liquid crystal display module where the heat conducting member 12 having openings 12a and 12b is placed in the periphery of a pair of semiconductor devices 10 is cited. As shown in FIG. 4, when a heat conducting member 12 is provided on the second printed circuit board 5, however, the invention is not limited to this, and a number of heat conducting members 12 in block form without openings may, of course, be provided in the periphery of the semiconductor devices 10, for example. At this time, the structure in the cross section along line F-F′ in FIG. 4 is the same as the configuration in the cross section in FIG. 2B.

In the arrangement of the heat conducting member 12 in the liquid crystal display module according to the second embodiment, the heat releasing terminals 1001 of the semiconductor devices 10 and the heat conducting member 12 do not make contact, and the area of the heat conducting member 12 that makes contact with the second printed circuit board 5 and the area of the rear thereof may be smaller than in the heat conducting member 12 in the first embodiment. However, the area of contact between the heat conducting member 12 and the second printed circuit board 5 and the area of contact between the heat conducting member 12 and the upper frame member 8 are sufficiently greater than the are of the region occupied by the semiconductor device 10 on the second printed circuit board. Therefore, though the efficiency of heat release of the heat conducting member 12 in the liquid crystal display module according to the second embodiment is low in comparison with in the first embodiment, the heat diffusing through the second printed circuit board 5 can be efficiently conveyed to the upper frame member 8.

In addition, the heat conducting member 12 in the second embodiment has a simple form in comparison with the heat conducting member 12 in the first embodiment, and therefore, the processability is high, and the heat conducting member 12 is easy to paste to the second printed circuit board 5.

In addition, the entire surface of the heat conducting member 12 which faces the second printed circuit board 5 is pasted to the second printed circuit board 5 in the second embodiment, and therefore, the adhesion with the second printed circuit board 5 is high, and the adhesion with the upper frame member 8 is also high.

In addition, though in the example shown in FIG. 4, three heat conducting members 12 are provided on the two sides of a pair of semiconductor devices 10 and between the two semiconductor devices 10, the invention is not limited to this, and any number of heat conducting members 12 may, of course, be provided in any location.

Though the present invention is described concretely on the basis of the above described embodiments, the present invention is not limited to the above described embodiments and various modifications are, of course, possible within such a scope as not to deviate from the gist of the present invention.

Though an example where heat conducting members 12 made of rubber (elastic body) are provided is cited in the first and second embodiments, the heat conducting members 12 are not limited to these, and may be made of a material other than an elastic body.

An example of a liquid crystal display module where a source driver 9A (first drive circuit) is provided on the first flexible wiring board 2A and a gate driver 9B (second drive circuit) is provided on the first flexible wiring board 2B, as shown in FIG. 1D, is cited in the first and second embodiments. However, the source driver 9A and the gate driver 9B may be provided on the TFT substrate 101, for example, instead of the first flexible wiring boards 2A and 2B. At this time, the source driver 9A and the gate driver 9B provided on the TFT substrate 101 may be integrated circuit devices in chip form or integrated circuits incorporated in the TFT substrate 101.

1. A liquid crystal display device, comprising: a liquid crystal display panel; a number of flexible wiring boards connected to said liquid crystal display panel; a first drive circuit and a second drive circuit provided on said flexible wiring boards or said liquid crystal display panel; a printed circuit board having wires for transmitting an external signal to said first drive circuit and second drive circuit and connected to said flexible wiring boards; a semiconductor device mounted on said printed circuit board; and an upper frame member made of a metal which covers an outer periphery portion of said liquid crystal display panel and said printed circuit board, characterized in that
a heat conducting member having heat conductance is provided on the surface of said printed circuit board which faces said upper frame member, and
said heat conducting member makes contact with said upper frame member.

2. The liquid crystal display device according to claim 1, characterized in that
the liquid crystal display device has a backlight unit provided on the rear of said liquid crystal display panel, and
said printed circuit board is provided between a side portion of said backlight unit and said upper frame member.

3. The liquid crystal display device according to claim 1, characterized in that
said heat conducting member has an opening or a recess on the surface facing said printed circuit board, and
said semiconductor device is provided on the surface of said printed circuit board facing said upper frame member and in said opening or recess of said heat conducting member.

4. The liquid crystal display device according to claim 1, characterized in that
said semiconductor device is provided on the surface of said printed circuit board facing said upper frame member, and
said heat conducting member is provided in the vicinity of said semiconductor device that is located on the surface of said printed circuit board facing said upper frame member.

5. The liquid crystal display device according to claim 1, characterized in that a number of semiconductor devices are provided on the surface of said printed circuit board facing said upper frame member, and one or more heat conducting members are provided corresponding to the number and the locations of said semiconductor devices.

6. The liquid crystal display device according to claim 1, characterized in that
said semiconductor device has a heat releasing terminal for conducting heat to said printed circuit board, and
said heat releasing terminal makes contact with said heat conducting member.

7. The liquid crystal display device according to claim 1, characterized in that
said first drive circuit is a drive circuit for sending a video signal to said liquid crystal display panel, and
said semiconductor device is a transistor for generating a power applied to said first drive circuit.

8. The liquid crystal display device according to claim 1, characterized in that said first drive circuit and said second drive circuit are integrated circuit parts in chip form, respectively, and mounted on said flexible wiring boards.

9. The liquid crystal display device according to claim 1, characterized in that said heat conducting member is formed of an elastic body.

10. The liquid crystal display device according to claim 1, characterized in that the height of said heat conducting member from the surface of said printed circuit board facing said upper frame member is greater than the height of said semiconductor device from the surface facing said upper frame member.

11. The liquid crystal display device according to claim 1, characterized in that the area of the surface of said heat conducting member which makes contact with said printed circuit board and the surface of said heat conducting member which makes contact with said upper frame member is greater than the area of the region occupied by said semiconductor device on said printed circuit board.
